(19) United States
(12) Patent Application Publication
(10) Pub. No.: US 2007/0147604 A1
(43) Pub. Date: Jun. 28, 2007

(54) Integrated circuit having advanced encryption standard core and wrapper for validating advanced encryption standard core

(75) Inventor: Nithin Salgunan, Bucheon-si (KR)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Dongbu Electronics Co., Ltd.

(21) Appl. No.: 11/644,742

(22) Filed: Dec. 21, 2006

(30) Foreign Application Priority Data
Dec. 28, 2005 (KR) 10-2005-0132663

(51) Int. Cl. H04L 9/28; H04K 1/06; H04L 9/00; H04K 1/04; H04K 1/00

(52) U.S. Cl. 380/28; 380/37

(57) ABSTRACT

Disclosed is an integrated circuit having an encryption core. The integrated circuit includes an encoder configured to encrypt an input plaintext using a first cipher key to produce a ciphertext, a decoder configured to decrypt the ciphertext using a second cipher to produce a decrypted plaintext, and a comparator configured to compare the input plaintext with the decrypted plaintext to produce a comparison result.

### BACKGROUND OF THE INVENTION

1. Field of the Invention

The present invention relates to an integrated circuit. More particularly, the present invention relates to an integrated circuit having an encryption intellectual property (IP) core, and a self-testing wrapper for validating performance of the encryption IP core.

2. Description of the Related Art

Due to recent technical development, application specific integrated circuits (ASICs) are developed at scales ranging from system-on-chip (SoC) regions to supersystem-on chip (SSoC) regions. These ASICs may include a large and growing number of cores and buses, and may include 100,000 or more logic gates. This is made possible by means of reusable intellectual property (IP) cores.

In semiconductor design, an IP core serves much the same purpose as a function library does in computer programming. An IP core generally provides a defined functionality that can be shared across many different implementations.

Encryption is one function that can be advantageously implemented in hardware using an IP core. For example, an IP core may implement the Advanced Encryption Standard (AES). AES is a variation of the Rijndael algorithm, which was adopted in the United States as Federal Information Processing Standard 197 (FIPS 197) on Nov. 26, 2001 by the National Institute of Standards and Technology (NIST). The Rijndael and AES algorithms encrypt and/or decrypt information using a symmetric cipher block.

Here, encryption refers to converting predetermined data (“plaintext”) into an encrypted representation of the data (“ciphertext”) such that it would be difficult or impossible to derive the plaintext from the ciphertext without access to the decryption mechanism. Thus, decryption refers to converting the ciphertext into the original plaintext. Generally, encryption and decryption are performed using an encryption algorithm to protect data on a computer, in transit on a computer network or other digital data transmission medium, or in a digital storage (e.g., in flash memory, in a magnetic storage medium such as a hard disk, in an optical storage medium such as a CD or DVD, or any other storage medium) . The AES algorithm generally encrypts and/or decrypts 128-bit blocks of data using a 128-, 192-, or 256-bit long cipher key.

ASIC producers and/or designers may combine an encryption IP core (e.g., an AES IP core) with additional IP cores and custom logic to design a complete integrated circuit (e.g., a complete silicon-on-chip implementation) . An ASIC producer and/or designer will generally test the performance of the IP cores to test the performance of the entire circuit. Each core can be tested through a wrapper. Here, the wrapper refers to a plurality of storages formed around each core. Data is input into each core through the wrapper in order to test the performance of the core, and an output from each core is output through the wrapper.

FIG. 1 is a block diagram of a conventional AES IP core using 128-bit cipher key in order to process 128-bit long data. As described above, the AES IP core can use a 128-, 192-, or 256-bit long cipher key for encryption. The Rijndael algorithm is designed to be applicable to data of 128 bits or more, and a cipher key having a length of 128 bits or more by repeatedly applying a cipher block. The AES algorithm (as specified in FIPS 197) is restricted such that the AES IP core can encrypt 128-bit blocks of data using a 128-, 192-, or 256-bit long cipher key.

Referring to FIG. 1, an AES IP core 10 may includes an encoder 200 and a decoder 300. The encoder 200 receives a 128-bit block of plaintext data, and encrypts the received plaintext into a 128-bit block of ciphertext data. The decoder 300 receives the ciphertext from the encoder 200, and decrypts the encrypted text into a 128-bit plaintext. In other words, the AES IP core 10 illustrated in FIG. 1 has a symmetric structure using the same cipher key, and encrypts and decrypts a 128-bit block of data using a 128-, 196-, or 256-bit long cipher key.

The encoder 200 and the decoder 300 may be separated from each other on different regions, as illustrated in FIG. 1, but they are generally incorporated into one IP core.

FIGS. 2 and 3 illustrate detailed configurations of the encoder and the decoder illustrated in FIG. 1.

Referring now to FIG. 2, a block diagram of encoder 200 is shown. Encoder 200 includes a controller 201, a cipher key extension module 210, an initial permutation module 220, a round permutation module 230, and a final permutation module 240 in order to perform encryption. The round permutation module 230 internally forms a loop for repetition. For example, in the case of a 128-bit long cipher key, the round permutation module 230 repeats the 128-bit long cipher key ten times. As illustrated, the round permutation module 230 encrypts and outputs data input through the initial permutation module 220 using a cipher key input through the cipher key extension module 210.

Referring now to FIG. 3 a block diagram of decoder 300 is shown. Decoder 300 includes a controller 301, a cipher key extension module 310, a cipher key inverting buffer 315, an initial permutation module 320, a round permutation module 330, and a final permutation module 340 in order to perform decryption. The cipher key inverting buffer 315 first stores cipher keys of all rounds, and outputs the stored cipher key with respect to each of the decrypted rounds in reverse order. Here, similar to the round permutation module 230 of FIG. 2, the round permutation module 330 internally forms a loop for repetition. For example, in the case of a 128-bit long cipher key, the round permutation module 330 repeats the 128-bit long cipher key ten times.

Thus, conventional encryption IP cores generally have a plurality of input/output (I/O) interfaces to receive and/or provide plaintext data, ciphertext data, and cipher keys. This may limit the performance of validation wrappers because wrappers generally have a relatively low number of pins available. For this reason, it is desirable to provide an encryption IP core that can be validated with a minimal number of pins.

### SUMMARY OF THE INVENTION

Accordingly, the present invention is directed to an integrated circuit capable of including a wrapper for testing an encryption intellectual property (IP) core to perform a self-test.

Further, an object of the present invention is to provide a wrapper for self-testing the encryption IP core.

According to a first embodiment of the present invention, an integrated circuit having an advanced encryption standard (AES) core includes an encoder configured to encrypt an input plaintext using a first cipher key to produce a cipher text, a decoder configured to decrypt the ciphertext using a second cipher key to produce a decrypted plaintext, and a comparator configured to compare the input plaintext with the decrypted plaintext to produce a comparison result.

According to a second embodiment of the present invention, a wrapper for validating an encryption core, in which the encryption core has an encoder and a decoder. The encoder is configured to encrypt an input plaintext using a first cipher key to create a ciphertext. The decoder is configured to decrypt the ciphertext using a first cipher key to produce a decrypted plaintext. The wrapper includes a comparator configured to compare the input plaintext with the decrypted plaintext to produce a comparison result and a data generator configured to generate the first and second cipher keys and to produce the input plaintext.

### BRIEF DESCRIPTION OF THE DRAWINGS

FIG. 1 is a block diagram of a conventional encryption intellectual property (IP) core;

FIG. 2 is a detailed block diagram of the encoder illustrated in FIG. 1;

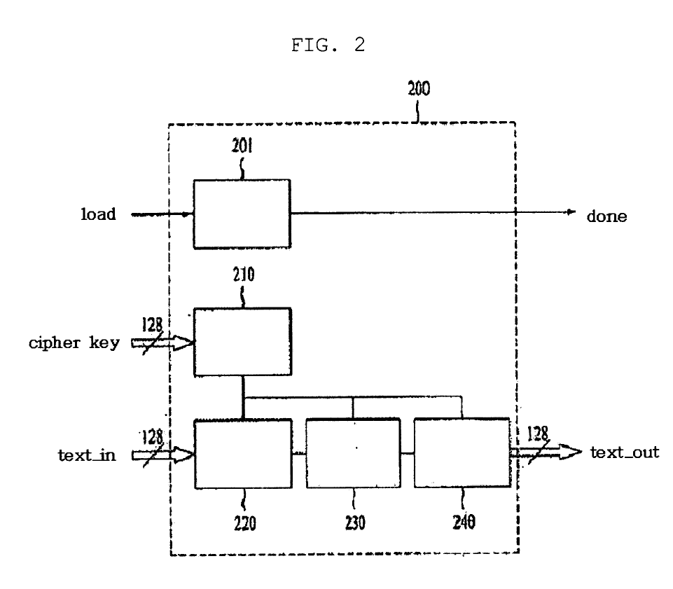

FIG. 3 is a detailed block diagram of the decoder illustrated in FIG. 1; and

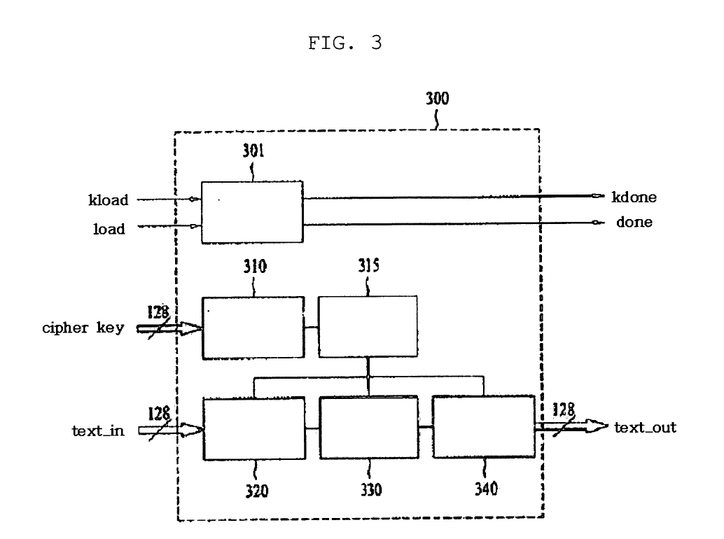

FIG. 4 is a block diagram of an encryption IP core according to an embodiment of the present invention.

### DETAILED DESCRIPTION OF THE PREFERRED EMBODIMENTS

Hereinafter, an integrated circuit having an encryption core and a wrapper for validating the encryption core in accordance with an exemplary embodiment of the present invention will be described with reference to the accompanying drawings.

In one aspect, the present invention relates to an integrated circuit. The integrated circuit includes an encoder configured to encrypt an input plaintext using a first cipher key to produce a ciphertext, a decoder configured to decrypt the ciphertext using a second cipher key to produce a decrypted plaintext, and a comparator configured to compare the input plaintext with the decrypted plaintext to produce a comparison result.

In a further embodiment, the integrated circuit further comprises a data generator configured to generate the first and second cipher keys and to produce the input plaintext.

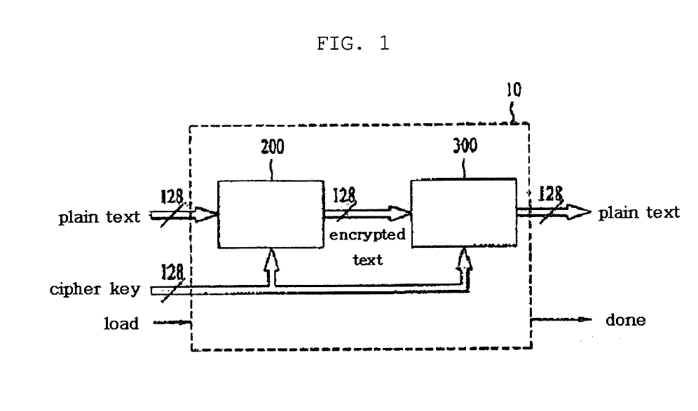

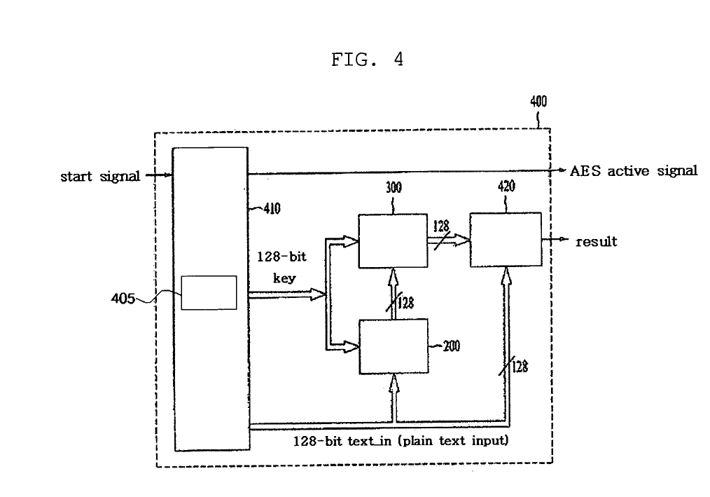

Referring now to, FIG. 4 a block diagram of an encryption intellectual property (IP) core according to an embodiment of the present invention is shown. As illustrated in FIG. 4, the encryption IP core 400 includes a data generator 410 and a comparator 420 in addition to an encoder 200 and a decoder 300 which are as illustrated in FIG. 1.

As in FIG. 4, an output of the encoder 200 is directly connected to an input of the decoder 300. Both the encoder 200 and the decoder 300 make use of one or more cipher keys. For many encryption algorithms, the cipher key(s) used in the encoder 200 will have the same length as the cipher key(s) used in the decoder 300. In symmetric encryption algorithms (e.g., the AES encryption algorithm) the cipher keys will be identical. The length of the cipher key will depend on the encryption algorithm used.

In one exemplary embodiment, the input plaintext and the decrypted plaintext include 128-bit data. In another embodiment, the first and second cipher keys have the same length. In yet another embodiment, the first cipher key is identical to the second cipher key.

In a preferred embodiment, the encryption core implements the Advanced Encryption Standard (AES). Thus, the encoder is further configured to encrypt the plaintext according to the Advanced Encryption Standard (AES) and the decoder is further configured to decrypt the ciphertext according to the AES. Thus, in accordance with the AES, each of the cipher keys has a length of 128 bits, 192 bits, or 256 bits. Accordingly, in another embodiment each of the cipher keys has a length of 128-bits, 192-bits, or 256-bits.

In another exemplary embodiment, only one cipher key is used in the encryption IP core 400, and the used cipher key has an invariable value. In a further embodiment the cipher key may be allocated at design time. For example, the cipher key may be allocated by means of a parameter statement in a hardware description language (e.g., a hardware description language based on Verilog). For purposes of encryption core validation, the cipher key may be a simple 128-bit value such as:
128′hABCD_ABCD_ABCD_ABCD_ABCD_ABCD_ABCD_ABCD.

In another embodiment, the data generator further includes a counter configured to produce the input plaintext. In a further embodiment, the counter counts from 0 (null) to a value determined according to a data size of the plaintext.

In a preferred embodiment, the integrated circuit has three 1-bit input signals and two 1-bit output signals. The three input signals include a clock signal, a reset signal, and an operation signal. The two output signals include a first signal indicating an operation state of the encryption core, and a second signal indicating an error state during encryption and/or decryption.

In a further embodiment, the data generator is configured to generate the first and second cipher keys and to produce the input plaintext when the clock signal and a start signal are in an active state. In another embodiment, the data generator restarts operation when the reset signal is in an active state. In yet another embodiment, the data generator provides the first signal informing that the encryption core is in an active state when the encryption core normally performs the encryption and decryption of data. In still another embodiment, the comparator is further configured to receive the input plaintext, compare the input plaintext with the decrypted plaintext, and output the second signal corresponding to the comparison result.

Referring again to FIG. 4, when the encryption core 400 is reset, the cipher key value may be loaded into a counter 405. The counter 405 repeatedly counts from 0 (null) to a maximum value, i.e. 128, and serves to provide a 128-bit input plaintext into the encoder 200.

The encoder 200 encrypts the 128-bit input plaintext, and creates a cipher text. When using the AES, the ciphertext will generally have the same size as the input plaintext. The decoder 300 decrypts the ciphertext into a decrypted plaintext. When the encryption core is behaving properly, the decrypted plaintext will be identical to the input plaintext. Thus, when using the AES the decrypted plaintext should have the same size as the ciphertext.

The data generator 410 provides the cipher keys to the encoder 200 and the decoder 300, and provides the plaintext to the encoder 200 and the comparator 420 that will be described below.

In another embodiment, when a clock signal and a start signal are simultaneously applied to the data generator 410 in order to initiate operation of the data generator 410, the data generator 410 provides the cipher keys to the encoder 200 and the decoder 300, and provides the input plaintext to the encoder 200 and the comparator 420.

In a further embodiment, when a reset signal is applied after the operation of the data generator 410 is stopped due to an error, the data generator 410 restarts its operation by providing the cipher keys and the input plaintext.

In yet another embodiment, when the encryption IP core 400 normally encrypts and decrypts the data, the data generator 410 generates a first signal informing that the encryption IP core 400 is in an active state, and provides the first signal to the outside.

The comparator 420 receives the input plaintext (e.g., the same input plaintext that was provided to encoder 200) from the counter, and compares the input plaintext with the decrypted plaintext from the decoder 300. As a result of the comparison, when it is determined that an error occurs, the comparator 420 outputs a second signal informing the result to the outside. In this case, the encryption IP core 400 stops its operation and performs a reset operation, thereby performing its operation again.

In another aspect, the invention relates to a wrapper for validating an encryption core. The encryption core has an encoder configured to encrypt an input plaintext using a first cipher key to produce a ciphertext and a decoder configured to decrypt the ciphertext using a second cipher key to produce a decrypted plaintext. The wrapper comprises a comparator configured to compare the input plaintext with the decrypted plaintext to produce a comparison result and a data generator configured to generate the first and second cipher keys and to produce the input plaintext.

Referring again to FIG. 4, the wrapper may comprise the data generator 410 and the comparator 420, formed around an encryption IP core including the encoder 200 and the decoder 300. The wrapper generally validates whether or not the encryption IP core 400 operates correctly.

In one embodiment, each of the cipher keys has a length of 128-bits, 192-bits, or 256-bits. In another embodiment, the data generator further includes a counter configured to produce the input plaintext. In a further embodiment, counter counts from 0 (null) to a value determined according to a data size of the plaintext.

In a preferred embodiment, the encryption core includes three input signals including a clock signal, a reset signal, and an operation signal, and two output signals including a first signal indicating an operation state of the encryption core and a second signal indicating an error state during encryption and/or decryption.

In another preferred embodiment, the encryption core implements the AES. Thus, the encoder is further configured to encrypt the plaintext according to the AES and the decoder is further configured to decrypt the ciphertext according to the AES.

As can be seen from the foregoing, according to the present invention, the testing wrapper capable of validating performance of the encryption IP core is formed together in the encryption IP core, so that the performance of the encryption IP core can be tested with a minimal number of pins.

Further, according to the present invention, an ASIC chip, field programmable gate array (FPGA), or other integrated circuit device including the encryption IP core can be easily manufactured.

While the invention has been shown and described with reference to the exemplary embodiment thereof, it will be understood by those skilled in the art that various changes in form and details may be made therein without departing from the spirit and scope of the invention as defined by the appended claims.

What is claimed is:

1. An integrated circuit having an encryption core, the integrated circuit comprising:
an encoder configured to encrypt an input plaintext using a first cipher key to produce a ciphertext;
a decoder configured to decrypt the ciphertext using a second cipher key to produce a decrypted plaintext; and
a comparator configured to compare the input plaintext with the decrypted plaintext to produce a comparison result.

2. The integrated circuit as claimed in claim 1, further comprising a data generator configured to generate the first and second cipher keys and to produce the input plaintext.

3. The integrated circuit as claimed in claim 2, wherein each of the cipher keys has a length of 128-bits, 192-bits, or 256-bits.

4. The integrated circuit as claimed in claim 2, wherein the data generator further includes a counter configured to produce the input plaintext.

5. The integrated circuit as claimed in claim 4, wherein the counter counts from 0 (null) to a value determined according to a data size of the plaintext.

6. The integrated circuit as claimed in claim 2, wherein the integrated circuit has at least three 1-bit input signals and at least two 1-bit output signals, wherein the at least three input signals include a clock signal, a reset signal, and an operation signal and the at least two output signals include a first signal indicating an operation state of the encryption core, and a second signal indicating an error state during encryption and/or decryption.

7. The integrated circuit as claimed in claim 6, wherein the data generator is further configured to generate the first and second cipher keys and to produce the input plaintext when the clock signal and a start signal are in an active state.

8. The integrated circuit as claimed in claim 7, wherein the data generator restarts operation when the reset signal is in an active state.

9. The integrated circuit as claimed in claim 6, wherein the data generator provides the first signal informing that the encryption core is in an active state when the encryption core normally performs the encryption and decryption of data.

10. The integrated circuit as claimed in claim 6, wherein the comparator is further configured to receive the input plaintext, compare the input plaintext with the decrypted plaintext, and output the second signal corresponding to the comparison result.

11. The integrated circuit as claimed in claim 2, wherein the input plaintext and the decrypted plaintext include 128-bit data.

12. The integrated circuit as claimed in claim 2, wherein the first and second cipher keys have the same length.

13. The integrated circuit as claimed in claim 2, wherein the first cipher key is identical to the second cipher key.

14. The integrated circuit as claimed in claim 1, wherein the encoder is further configured to encrypt the plaintext according to the Advanced Encryption Standard (AES) and the decoder is further configured to decrypt the ciphertext according to the AES.

15. A wrapper for validating an encryption core that has an encoder configured to encrypt an input plaintext using a first cipher key to produce a ciphertext and a decoder configured to decrypt the ciphertext using a second cipher key to produce a decrypted plaintext, the wrapper comprising:
a comparator configured to compare the input plaintext with the decrypted plaintext to produce a comparison result; and
a data generator configured to generate the first and second cipher keys and to produce the input plaintext.

16. The wrapper as claimed in claim 15, wherein each of the cipher keys has a length of 128-bits, 192-bits, or 256-bits.

17. The wrapper as claimed in claim 15, wherein the data generator further includes a counter configured to produce the input plaintext.

18. The wrapper as claimed in claim 17, wherein the counter counts from 0 (null) to a value determined according to a data size of the plaintext.

19. The wrapper as claimed in claim 15, wherein the encryption core includes three input signals including a clock signal, a reset signal, and an operation signal, and two output signals including a first signal indicating an operation state of the encryption core and a second signal indicating an error state during encryption and/or decryption.

20. The wrapper as claimed in claim 15, wherein the encoder is further configured to encrypt the plaintext according to the Advanced Encryption Standard (AES) and the decoder is further configured to decrypt the ciphertext according to the AES.
